(19) United States
(12) Patent Application Publication
(10) Pub. No.: US 2024/0329687 A1
(43) Pub. Date: Oct. 3, 2024

(54) AUTOMATIC RESIZING DISPLAYS

(71) Applicant: QUALCOMM Incorporated, San Diego, CA (US)

(72) Inventors: Shubhobrata DUTTA CHOUDHURY, New Delhi (IN); Francis JOSEPH, Thrissur (IN)

(21) Appl. No.: 18/193,565

(22) Filed: Mar. 30, 2023

(51) Int. Cl. G06F 1/16; G05B 15/02

(52) U.S. Cl. CPC G06F 1/1652; G05B 15/02

(57) ABSTRACT

Systems and techniques are described herein for automatically physically resizing a resizable display. For instance, a process can include determining an application is being started, determining a display size for a resizable display based on the application being started, and resizing the resizable display based on the determined display size.

### FIELD

The present disclosure generally relates to physically resizing a display to vary an amount of viewable area available on the display. For example, aspects of the present disclosure are related to systems and techniques for providing automatic rolling displays.

### BACKGROUND

Flexible display technologies allow a device with a relatively smaller display (or screen) to expand into a larger display. For example, a device with a flexible display can unfold to reveal a display that is larger than a size of the display when the device is folded. As another example, a device with a rollable display may roll or unroll the display to adjust a size of the display. Flexible organic light emitting diode (OLED) displays and other display technologies, which can use plastic and other flexible materials as a substrate, have helped enable such flexible displays.

Flexible display technologies can be enhanced by using a rollable display instead of a folding display. In a rollable display, a physical size of the display may be changed. For example, one or more portions of the display may expand and/or retract from one or more portions of the device. These rollable displays enable new form factors and experiences for users.

One experience that rollable displays can enable includes variable rolling displays where a rollable display can be unrolled to a size in between a minimum size of the display and a maximum size of the display. For example, a rollable display can assume many more positions than a minimum, fully retracted position and a maximum, fully extended position.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for physically resizing a resizable display. In one illustrative example, an apparatus for resizing a resizable display is provided. The apparatus includes a memory, a resizable display, and a processor coupled to the memory. The processor is configured to: determine an application is being started; determine a display size for the resizable display based on the application being started; and resize the resizable display based on the determined display size.

As another example, a method for physically resizing a resizable display is provided. The method includes: determining an application is being started; determining a display size for a resizable display based on the application being started; and resizing the resizable display based on the determined display size.

In another example, a non-transitory computer-readable medium is provided that has stored thereon instructions that, when executed by at least one processor, cause the at least one processor to: determine an application is being started; determine a display size for a resizable display based on the application being started; and resize the resizable display based on the determined display size.

As another example, an apparatus for physically resizing a resizable display is provided. The apparatus includes: means for determining an application is being started; means for determining a display size for a resizable display based on the application being started; and means for resizing the resizable display based on the determined display size.

In some aspects, the apparatus comprises a mobile device (e.g., a sensor device, a mobile telephone or so-called “smart phone”, a tablet computer, or other type of mobile device), a wearable device, a personal computer, a laptop computer, a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SOC), in accordance with some examples.

FIG. 2 is a diagram illustrating an example portable device including a resizable display panel, in accordance with aspects of the present disclosure.

FIG. 3 is a flow diagram illustrating an example of a process for automatically resizing a display based on a size history, in accordance with aspects of the present disclosure.

FIGS. 4A-4E illustrate automatic display resizing based on a size history, in accordance with aspects of the present disclosure.

FIG. 5 is a is a flow diagram illustrating a contextual automatic display resize technique 500, in accordance with aspects of the present disclosure.

FIGS. 6A-6D are drawings illustrating determining a resizable display size for an automatic rollable display based on application display information, in accordance with aspects of the present disclosure.

FIG. 7 is a flow diagram for a process for automatically resizing a resizable display, in accordance with aspects of the present disclosure.

FIG. 8 illustrates an example computing device architecture of an example computing device, in accordance with aspects of the present disclosure.

FIG. 9 is a block diagram of a UE, in accordance with aspects of the present disclosure.

FIG. 10 illustrates an example wireless communications system, in accordance with aspects of the present disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

In some cases, resizable displays (e.g., physically resizable displays) may allow a display to be physically extended along at least one axis between a minimum size and a maximum size such as to adjust an amount of viewable area of the display between the minimum size and the maximum size. For example, a portion of a display may be rolled up (e.g., retracted) when the display is at its minimum size. The display may be unrolled (e.g., extended) to its fullest extent when the display is at its maximum size. Along with the minimum and maximum size, it may also be useful to allow the resizable display to be extended into positions between the minimum size and the maximum size. In some cases, it may be useful to tailor the size of the resizable display to an application being used. Tailoring the size of the resizable display to the application can help optimize the resizable display to an activity a user of the resizable display is trying to perform. Thus, in some cases, techniques to automatically resize a resizable display may be useful. In some cases, the resizable display described herein may refer to a first portion of a resizable display, e.g., a rollable display. The size of the first portion can be changed by a transformation, e.g., rolling, of the transformable display. In some cases, the first portion of the resizable display is on a first side (e.g., front side) of a UE, and the device further includes a second portion of the resizable display on a second side (e.g., back side) of the UE. The sizes of the first and second portions can be changed by transformation. e.g., rolling, of the transformable display, while a total amount of viewable area of the first and second portion of the resizable display may be constant. Thus, a physically resizable display may refer to a display with a physically changeable amount of viewable area on a single side of the device.

Systems, apparatuses, electronic devices, methods (also referred to as processes), and computer-readable media (collectively referred to herein as “systems and techniques”) are described herein for automatically extending or retracting a resizable display (e.g., a physically resizable display, such as rolling/unrolling a physically resizable display by extending or retracting the physically resizable display). For example, a resizeable display of a device may be automatically extended or retracted based on an application being executed by the device (e.g., an application that is started, launched, or switched to by the device, such as based on user input via a user interface of the device).

In some cases, such as where a user has previously used the application, a size (e.g., how extended or retracted the display is) of the resizable display (e.g., rollable display) may be based on a previous size of the resizable display when the user previously used the application. In such cases, where the application has a predefined (e.g., default) size and the user overrides the predefined size by manually resizing the display to a user-adjusted size, the user-adjusted size may be retained and the resizable display may be returned to the user-adjusted size the next time the application is used by the device (e.g., the next time the device launches the application based on input from the user).

In some cases, such as where there is no user-adjusted or default size, the resizable display may automatically select a size for the resizable display. In some cases, the resizable display size may be based on an aspect ratio of the content to be displayed and/or one or more control interfaces (e.g., tools, widgets, menus, and the like) of the application that may be displayed along with the content. For example, the size of the resizable display may be set based on a distance at which the content of the application and the control interfaces of the application can be displayed on the resizable display without an overlay being used (e.g., where the control interfaces are placed over the content of the application). For example, for video playback, the resizable display may be resized (e.g., by extending or retracting a rollable display) to fit both the video as well as playback tools for the video playback on the resizable display without the playback tools being overlaid over the video being played back.

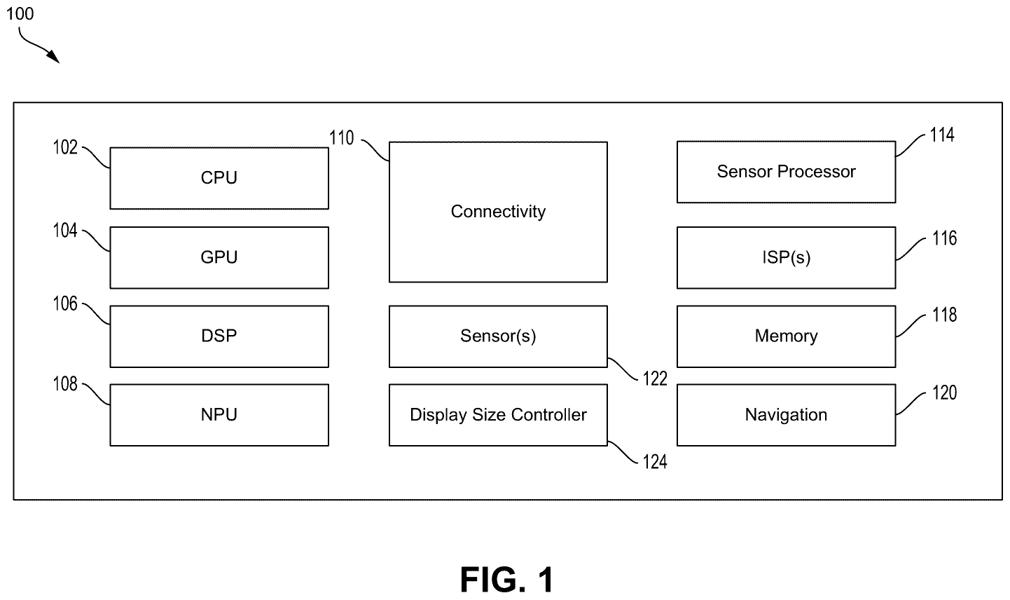

Various aspects of the present disclosure will be described with respect to the figures. FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, and a connectivity block 110, which may include fifth generation (5G) connectivity, fourth generation long term evolution (4G LTE) connectivity, Wi-Fi connectivity, USB connectivity, Bluetooth connectivity, Ultrawideband (UWB) and the like. In one implementation, the NPU is implemented in the CPU 102, DSP 106, and/or GPU 104. The SOC 100 may also include a sensor processor 114, image signal processors (ISPs) 116, a display size controller 124 and/or navigation module 120, which may include a global navigation satellite system (GNSS) and/or global positioning system (GPS). In some cases, the display size controller may be implemented by the CPU 102 and the memory block 118, rather than being implemented as a separate component of the SOC 100 as shown in FIG. 1.

In some cases, SOC 100 and/or components thereof may include a display size controller 124 configured to determine and/or set a size of a viewable area (e.g., portion) for a display coupled to the SOC 100. In some cases, the display size controller 124 may control one or more mechanical devices that may be used to control the size of the viewable area (e.g., portion) of the display. The display size controller 124 may be coupled to a resizable display panel (not shown). The resizable display panel may include an output surface capable of using image display technology (e.g., liquid crystal display (LCD), light-emitting diode (LED), organic LED (OLED), gas plasma, and/or the like) to present content in visual form. The resizable display panel may include a flexible structure that allows at least a portion of the resizable display panel to extend from and/or retract into an interior portion of a device to vary a size of the output surface that is used to present content in visual form, as described herein. The flexibility of the resizable display allows the display size to be precisely tailored to activities being performed on the device.

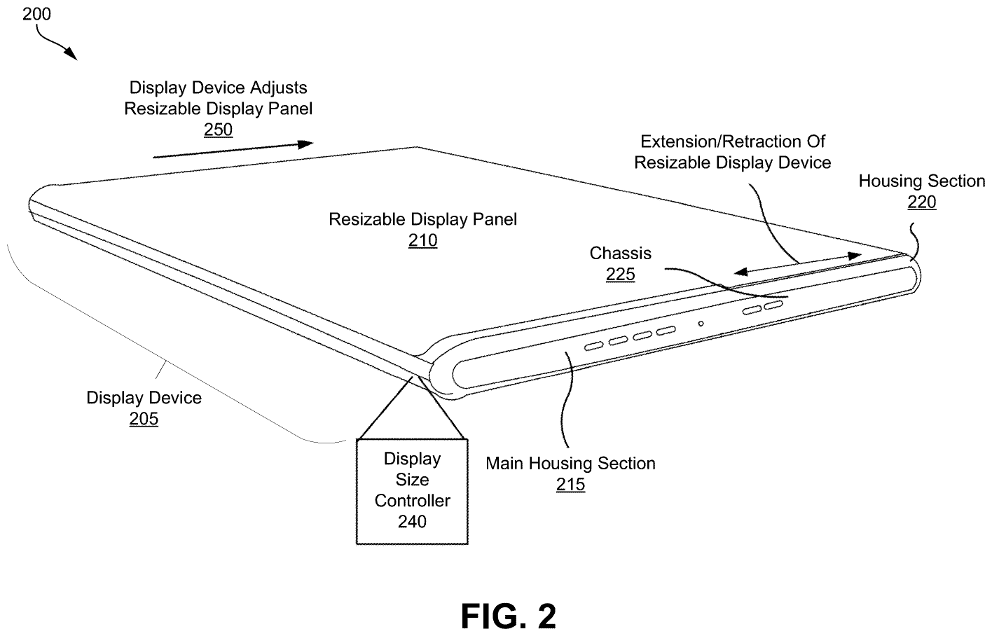

FIG. 2 is a diagram illustrating an example portable device 200 including a resizable display panel, in accordance with aspects of the present disclosure. As shown in FIG. 2 a display device 205 of the portable device 200 includes a resizable display panel 210, a main housing section 215, a housing section 220, a chassis 225, and a display size controller 240 (e.g., display size controller 124). As shown in FIG. 2, and by reference number 250, the display device 205 adjusts the resizable display panel 210. As an example, a user may provide an input to the portable device 200. The input may be associated with adjusting a size of a viewable portion of the resizable display panel 210. For example, the user may provide the input via an input element displayed via the resizable display panel 210, a physical button included on the main housing section 215 and/or the housing section 220, and/or the like. The input may be received by the display size controller 240 and the display size controller may resize the resizable display panel 210 based on the input. As another example, the display size controller 240 may determine a size for the resizable display panel 210, for example, based on an application launched/and or active on the resizable display panel 210 and the display size controller 240 may resize the resizable display panel 210 based on the determined size.

In some cases, display size controller 240 may cause an adjustment mechanism to resize the resizable display panel 210 based on the input. In some aspects, the display size controller 240 may determine a new size of the viewable portion of the resizable display panel 210 based on the size of the viewable portion. The display size controller 240 may determine a current size of the viewable portion based on accessing information stored in a memory (e.g., memory block 118) associated with the display device 205. For example, the information stored in the memory may include information indicating a current size of the viewable portion of the resizable display panel 210, a current distance between an end (e.g., an edge) of the resizable display panel 210 and the housing section 220, and/or the like. In some cases, the resizable display panel 210 may extend/retract from (e.g., across or over) the housing section 220. In some cases, the distance (e.g., current distance) may be measured in a standard distance measurement, such as millimeters, centimeters, inches, and the like. In other cases, the distance may be a relative measurement, such as using percentages of a full extension (e.g., 90%, 80%, etc.) or of a full retraction (e.g., 120%, 150%, etc.). In other cases, the distance may be measured in an abstract form, such as size 1, 2, 3, etc. It may be understood that the above discussed distance measurements are intended to be illustrative and not exhaustive of how a distance may be measured. The display size controller 240 may determine the current size of the viewable portion based on the information indicating the current size of the viewable portion of the resizable display panel 210, the current distance between the end of the main housing section 215 and the housing section 220, and/or the like.

The display size controller 240 may determine a difference between the current size of the viewable portion and the new size of the viewable portion. The display size controller 240 may determine a size of a portion of the resizable display panel 210 to be extended from, or retracted into, an inner portion of the main housing section 215 based on the difference between the current size of the viewable portion and the new size of the viewable portion. In some cases, the resizable display panel 210 may be extended from the inner portion of the main housing section 215 across and/or around the housing section 220 (e.g., where the resizable display panel 210 wraps around the housing section 220). In some cases, the resizable display panel may retract/extend from the inner portion of the main housing section 215 via the housing section 220 (e.g., via one or more rollers within the housing section). The controller 240 may cause the adjustment mechanism to adjust the resizable display panel 210 to account for the difference between the current size of the viewable portion and the new size of the viewable portion.

In some cases, the controller 240 may cause the adjustment mechanism to cause the resizable display panel 210 to transition from a fully retracted position to an extended position. This resizing may be performed by components of the portable device 200, such as a mechanical adjustment mechanism, without a user having to physically extend/retract the resizable display panel 210. In some aspects, the fully retracted position corresponds to a smallest size of the viewable portion of the resizable display panel 210. In some cases, the extended position corresponds to a size of a viewable portion of the resizable display panel 210 that is greater than the smallest size of the viewable portion. For example, the extended position may correspond to a fully extended position (e.g., a size of the viewable portion is a maximum size), a partially extended position (e.g., a size of the viewable portion is greater than the smallest size and/or less than the maximum size), and/or the like. Although FIG. 2 illustrates the extension/retraction of the rollable display panel 210 along a width of the portable device 200, in other examples the extension/retraction can be along another direction, e.g., along a length of the portable device 200.

Generally, different users have different preferences for how they may hold and/or use a device. For example, certain users may prefer a landscape view for reading certain types of materials, such as work documents of a certain format, while the user may prefer portrait view for other materials, such as books. Additionally, how a user grips their device, their hand size, preferred finger for touching, and the like can all influence how a user may prefer to use a device. These varying preferences may present an opportunity for customizing a resizable display to tailor a physical display size (e.g., viewable area) to a user's preference.

In some cases, a device with a resizable display may be configured to automatically resize the display. For example, the device may be configured to determine a size of the display based on a resize history of an application being started. As another example, the size of the display may be determined based on content of the application, such as presence of certain user interface (UI) elements, overlays, and/or the like.

As indicated above, users may have different preferences as to how they prefer to interact with certain applications when using a resizable display. For example, a user may prefer to use a first application with the display sized between the minimum and the maximum size of the display, while they may prefer to use a second application with the maximum size of the display, and a third application with the minimum size of the display. It may be useful for a device with a resizable display to automatically physically adjust (e.g., resize) the size of the resizable display to accommodate differing user preferences based on the application being used.

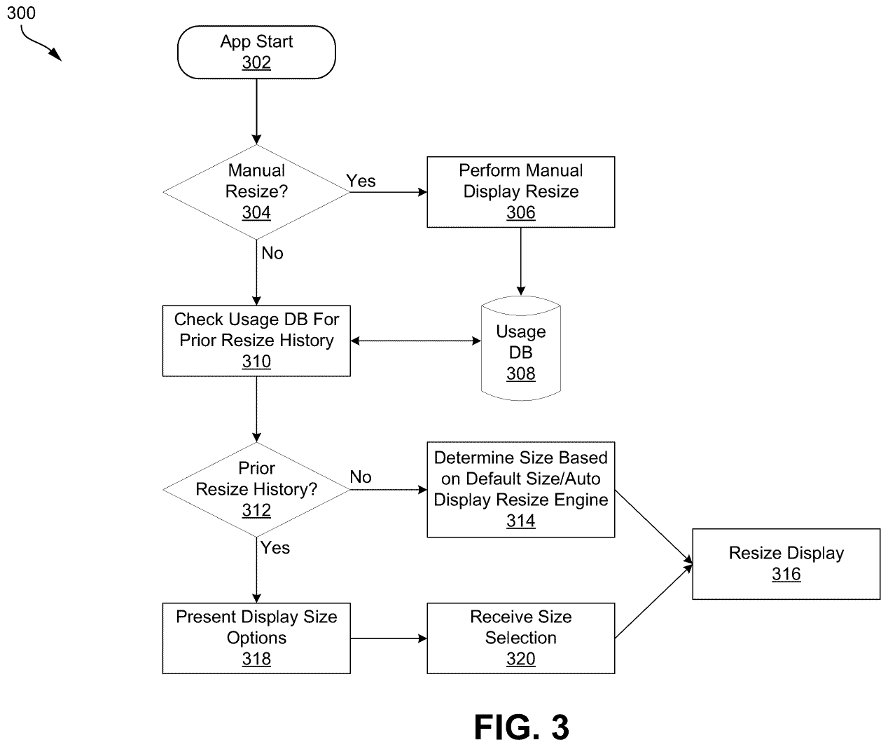

FIG. 3 is a flow diagram illustrating an example of a process 300 for automatically resizing a display based on a size history, in accordance with aspects of the present disclosure. In process 300, an indication that an application has been started may be received at operation 302, for example, by a display size controller, such as display size controller 240. For example, a user may interact with a user interface of a portable device, such as portable device 200, and cause an application to be started by the portable device, for example, by selecting an application. An indication of the application being started may be passed, for example by an operating system executing on a processor of the portable device to the display size controller. In some cases, task switching to the application from another application may also cause an indication that the application has been started to be received at operation 302.

In some cases, if a request for a manual resize of the resizable display is received at operation 304, then the manual display resize may be performed at operation 306. For example, the user interface may display a prompt asking if a user would like to physically resize the resizable display. If the user presses an input element displayed on the resizable display or a physical button on the portable to extend or retract the resizable display, then the display may extend or retract based on the user input. In some cases, the request for the manual resize may indicate a size for the resizable display. For example, the request may indicate that the resizable display should be extended to the maximum size or retracted to the minimum size. In other cases, the size of the resizable display may be indicated based on how long the input is received, for example, by holding down the button or receiving multiple taps of the input element until the display is resized to a user desired size. The user desired size may be associated with the application and the user desired size and associated application may be saved in an application usage database 308.

In some cases, the application usage database 308 may save information such as a per application display size usage (e.g., display sizes used on a per application basis), how often (e.g., a count) a particular size was used for the application, along with other information that may be used to determine the size of the display, such as display orientation (e.g., portrait/landscape), time of the day, and the like. In some cases, the application usage database 308 may include separate sets of information on a per user basis. In some examples, the application usage database 308 may include a look-up table including display sizes previously used for an application and how many times (e.g., a count) the display size was used for the application.

In some cases, if no request for a manual resize is received at operation 304, then the application usage database 308 may be checked at operation 310 for a prior size history associated with the application. For example, the application usage database 308 may be queried at operation 312 to determine if there is a prior size history associated with the application indicating one or more display sizes previously used for the application. In some cases, checking for a prior size history associated with the application at operation 310 may be performed substantially concurrently with, or while waiting for, an indication of a manual resize at operation 304. In some cases, if an indication of a manual resize is received at operation 304, at any operation of process 300, execution of other steps may be stopped/ignored, and the manual display resize may be performed at operation 306.

If there is no prior resize history for the application determined at operation 312, then a size of the display may be determined at operation 314 based on a default size and/or an auto display resize engine. In some cases, a default size may be to retain the current size. In other cases, default sizes may include a size associated with certain orientations of the portable device, a size based on a requested orientation/aspect ratio by the application, and the like. In some cases, the size of the display may be determined at operation 314 based on a previously used size of the display or contextual automatic resize technique, for example, determined by the auto resize engine. The auto display resize engine is discussed in more detail below. After a size is determined at operation 314, the display may be resized at operation 316 based on the determined size. If the determined size is the current size, the display size may be resized (e.g., retained) at operation 316 to the current size.

If there is prior size history for the application (e.g., the application is associated with previously used sizes), then a prompt with display size options may be displayed at operation 318. For example, a user interface element, such as a pop-up, notification, dialog box, and the like, may be displayed on a user interface. The user interface element may display a prompt requesting a selection of a display size to use for the application. In some cases, the user interface element may prompt for selection from among one or more previously used display sizes based on the prior size history for the application. For example, one or more previously used sizes for the display for the application may be presented. The one or more previously used sizes for the display may be ordered based on the display size most commonly used, display sizes most recently used, display sizes in increasing or decreasing order, display sizes most similar to an aspect ratio of the application, or the like. A size selection may be received at operation 320 based on the display size options displayed/presented at operation 318 and a display size of the resizable display may be determined based on the size selection received. For example, input to the prompt may be received via a user interface, such as a touch screen, to one of the sizes displayed. The display may then be resized at operation 316 based on the input (e.g., size selection) received at operation 320. In some cases, such as if an automatic resizing mode is enabled and there is a prior resize history for the application, operation 318 and operation 320 may be skipped, and the display may be resized at operation 316 based on the prior resize history without presenting display size options at operation 318 or receiving a size selection at operation 320.

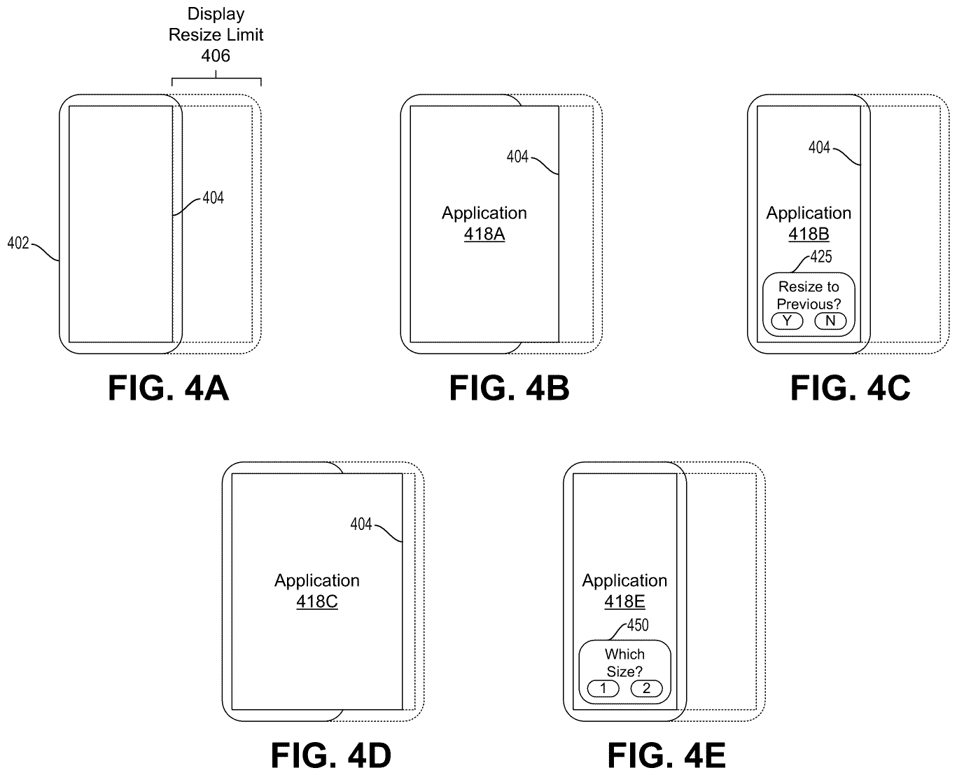

FIG. 4A-4E illustrate automatic display resizing based on a size history, in accordance with aspects of the present disclosure. In FIG. 4A, a portable device 402 is shown including a resizable (e.g., rollable) display 404 that is in a fully retracted (e.g., minimum size) state. The resizable display 404 may be expanded to any size up to a display resize limit 406 (e.g., a maximum size). As shown in FIG. 4B, in some cases, a user may manually resize the resizable display 404 when using an application 418A. In such cases, the size of the resizable display 404, after resizing, may be associated with the application 418A and saved, for example, to an application usage database, such as application usage database 308 of FIG. 3.

In some cases, the user may have previously resized the display for the application. In such cases, the previously used size may be saved, for example, in the application usage database. As shown in FIG. 4C, if the application 418B (e.g., the same application as application 418A) is launched again, a user interface element 425 may be displayed. The user interface element 425, such as a pop-up, overlay, dialog box, etc., may ask whether to resize the display to a previously used size (e.g., the size of resizable display 404). Based on a received indication whether to resize, the resizable display 404 may be resized. In some cases, the application usage database may be updated based on the received indication. For example, if the indication received is to resize the resizable display 404 shown in FIG. 4C to the same size as resizable display 404 of FIG. 4B, then a count number entry corresponding to the display size for application 418B may be incremented.

As shown in FIG. 4D, in some cases, the resizable display 404 may be manually resized to a second size for the application 418C (e.g., the same application as applications 418A and 418B). In such cases, as shown in FIG. 4E, a next time the application 418E is launched, user interface element 450 may be displayed. The user interface element 450, such as a pop-up, overlay, dialog box, etc., may ask whether to resize the display to a previously used size. In some cases, the user interface element 450 may present multiple previously used display sizes, such as one which correlates with the size of resizable display 404 shown in FIG. 4B, and one which correlates with the size of resizable display 404 shown in FIG. 4D. In some cases, the multiple sizes may be ordered based on the display size most commonly used (e.g., based on the count number entry associated with the different display sizes), display sizes most recently used, display sizes in increasing or decreasing order, display sizes most similar to an aspect ratio of the application, or the like.

In some cases, automatically resizing a resizable display based on previously used sizes of the display when using an application helps address a useability concern with resizable displays involving user inertia by reducing an amount of effort needed to resize a display. That is, manually resizing a display requires effort and time of a user and the user may simply not resize the display manually, even if the resized experience is better, because of an amount of mental effort needed to manually adjust the display size. Automatically resizing the resizable display helps adapt the display to the user and helps personalize the display to the user. Additionally, adjusting the display to previously used sizes, allows the display to leverage the effort previously made by the user when they did manually resize the display. Further, resizing the display based on the application being used acknowledges that different applications have different use cases and that these use cases may influence how the user prefers to interact with the display. For example, a user may prefer a wider sized display for certain use cases, such as comparing work documents, while the user may prefer a narrower sized display for reading other materials, such as ebooks.

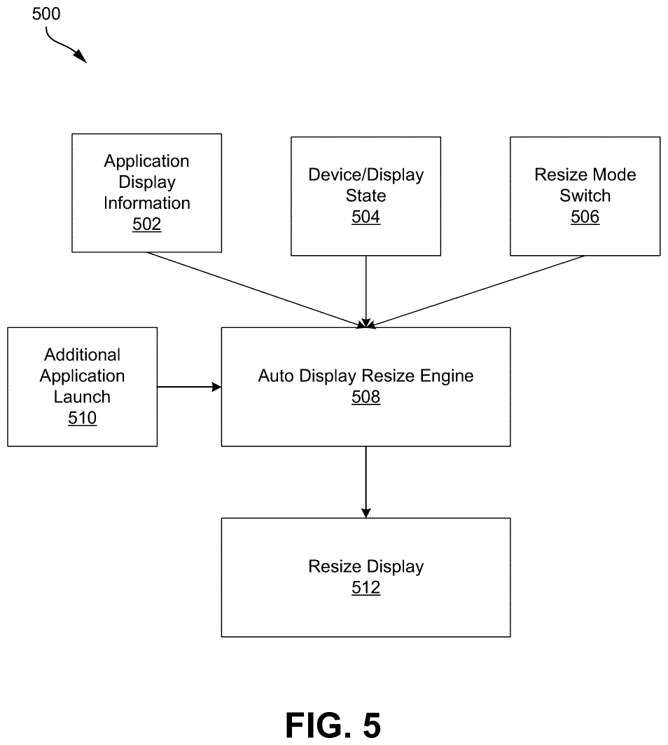

FIG. 5 is a flow diagram illustrating a contextual automatic display resize technique 500, in accordance with aspects of the present disclosure. In some cases, the contextual automatic display resize technique 500 may be performed by an auto display resize engine, such as auto display resize engine discussed with respect operation 314 of the process 300 of FIG. 3, within the context of the process 300 for automatically resizing a display based on a size history as discussed in FIG. 3. In other cases, the contextual automatic display resize technique 500 may be performed independent of the process 300 for automatically resizing a display based on size history as discussed in FIG. 3.

In FIG. 5, based on a determination that an application has been launched (or switched to) at block 510, application display information 502, display state and device state information 504, and resize mode switch information 506 may be passed into an auto display resize engine 508 to determine whether to perform an automatic resize of the resizable display, and if so, determine what size the display should be. In some cases, the application display information 502 may include information about displaying the application, such as resolution information, aspect ratio, orientation preferred/supported (e.g., portrait/landscape), any widgets, toolbars, overlays, or other control interface elements used to control and/or associated with the application, and the like that may be displayed in conjunction with the application. In some cases, the display state and device state information 504 may refer to information about the display or device, such as device orientation, a current size of the resizable display, a minimum and/or maximum size of the resizable display, resolution information, and the like.

In some cases, the resize mode switch information 506 may include information about a setting of the resize mode switch. For example, a device with a resizable display may include a set of automatic resize modes. A first resize mode may disable automatic resizing. If this automatic resize mode is set, then the resizable display may not perform automatic resizing and may only be resized manually. A second resize mode may enable automatic resizing. In this second resize mode, the resizable display may be automatically resized based on the determined display size (e.g., based on a prior size, or as discussed with respect to operation 314 of FIG. 3) for an application, for example, after launching the application. This automatic resizing of the resizable display may occur without prompting the user whether to resize the display prior to starting the resizing of the display. In some cases, in a third resize mode a prompt may be displayed before automatically resizing the display. For example, in the prompt prior to automatically resizing mode, after an application is launched, a prompt may be displayed requesting input as to whether the display should be resized. The prompt may include one or more options, such as not resizing, automatically resize based on a determined size, resizing to another prior size used for the application, resize to a maximum/minimum size, and the like. In some cases, additional resize modes may be included. Examples of such additional resize modes may include automatically resizing after a certain amount of time has passed since an application was launched, per-orientation resizing modes, and the like.

In cases where the resize mode is in one which allows the resizable display to be automatically resized at some point (e.g., not the first resize mode), the auto display resize engine 508 may determine a size for the resizable display based on, for example, the application display information 502 and display state and device state information 504. In some cases, the application display information 502 may include information about displaying the application, such as resolution information, aspect ratio, orientation preferred/supported (e.g., portrait/landscape), any widgets, toolbars, overlays, or other control interface elements used to control and/or associated with the application, and the like. Once the size is determined for the resizable display, the auto display resize engine 508 may resize the resizable display at block 512. The application display information 502 may be used to display the application on the display.

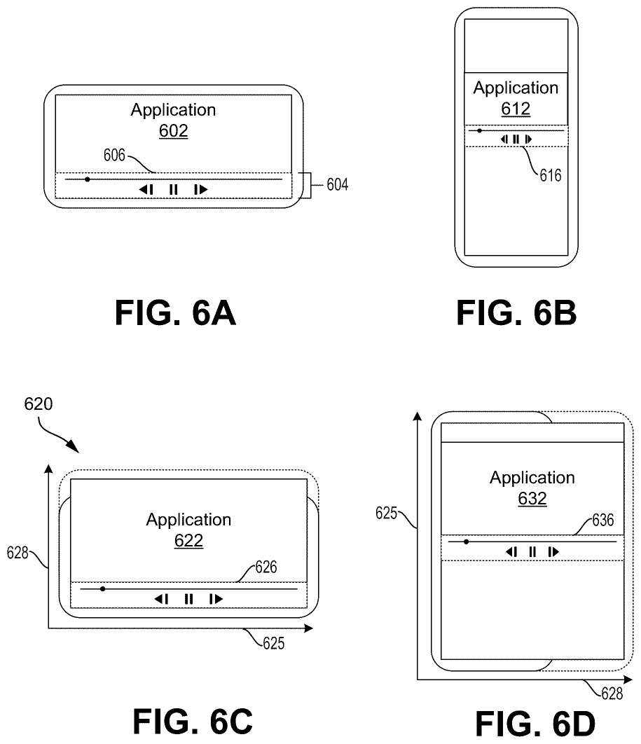

FIGS. 6A-6D are drawings illustrating determining a resizable display size for an automatic rollable display based on application display information, in accordance with aspects of the present disclosure. As an example, with reference to FIG. 6A, a primary portion of application 602 may be displayed at a certain resolution/aspect ratio along with a set of control interface elements 604 on an overlay 606. In some cases, the primary portion of the application may be a primary window (e.g., view) in which content of the application is displayed. In some cases, the primary window may be sized based on the content to be displayed. For example, a primary window for displaying video content of a video playback application may be sized based on the size/aspect ratio of the video being played back. The overlay may be associated with an overlay resolution and the overlay may be displayed/hidden based on, for example, touching the display. In some cases, the overlay may include control interfaces that may be used to interact with the application, such as to adjust settings of the application, adjust audio/video playback, control a game, and the like. In such cases, the application display information may include the application resolution/aspect ratio for the application 602 and the overlay resolution/aspect ratio for overlay(s) 606 used by the application 602.

Referring to FIG. 6B, in some cases, if the application, such as video playback application 612, can be displayed as indicated by the application display information along with the overlay 616, at the overlay resolution, with a current size (with or without reorientation) of the resizable display such that the overlay 616 can be displayed without covering (e.g., on top of, overlaying, overlapping) the playback application 612, then the current display size may be used as the determined display size (e.g., with a non-overlapping size, which may be a size of the application where there is no overlap between the content to be displayed and the control interface of the application).

Referring back to FIG. 6A, in some cases, if the overlay 606 would be displayed covering (e.g., overlaying) a portion of the video playback application 602, a different display size may be determined. In some cases, the size of the resizable display may be set such that the application 602 may be displayed along with the overlay 606 such that the overlay 606 does not block (e.g., cover, overlay, overlap) the application 602.

In FIG. 6C, in some cases, the size of the resizable display may be set based on a sum of the application resolution and the overlay resolution (or as a function of the application aspect ratio and overlay aspect ratio). For example, if the application 622 is sized based on (e.g., based on resolution, pixel density, etc. to fill/fit) a non-resizable axis 625 of the portable device 620, then the size of the resizable axis 628 may be based on a corresponding size of the application 622 and the overlay 626 on the resizable axis 628 according to the aspect ratio/resolution. The overlay 626 may then be displayed adjacent to the application 622 such that the overlay 626 does not cover the application 622. In some cases, the application may be rotated (e.g., reoriented from portrait to landscape, or landscape to portrait) to help maximize a viewable size of the application 622.

In some cases, the size of the resizable display may be set to a maximum size based on a size of the application 632 being displayed. For example, as shown in FIG. 6D, the application 632 may be configured to display in a certain orientation (e.g., landscape/portrait rotation mode). If a size of the application 632 and a size of the overlay 636, in the set rotation, fits within the size of the display along a non-resizable axis 625 and the aspect ratio of the application 632 and overlay 636 is such that the combined size of the application 632 and overlay 636 cannot exceed the size of the display along the non-resizable axis 625, then the size of the resizable display may be set to maximize a size of the application 632 along the resizable axis 628 (e.g., set to a maximum size of the resizable display).

In some cases, automatically resizing a resizable display contextually based on the application, such as based on the application display info, device/display state, and resize mode switch, also helps address the useability concern with resizable displays involving user inertia by reducing an amount of effort needed to resize a display. Automatically resizing the resizable display contextually differs from automatically resizing the resizable display based on usage history in that resizing based on context helps optimize the display experience for users which may not want to put in the effort to manually resize the display, but still want an optimum experience taking advantage of the sizes available from the resizable display. Moreover, the automatically resizing the display based on context can allow the display to be optimized to the application, for example, by allowing the display to be resized to an application's preferred resolution/aspect ratio/size, etc., which may improve how content of the application may be displayed. For example, by allowing the screen to be resized to match a particular resolution may help allow the content to be displayed in a native resolution without a need to resize/scale the content. Tailoring the size of the screen to the application may also help reduce an amount of processing power and/or battery power used to display the content by avoiding processing such as resizing/scaling the content to be displayed.

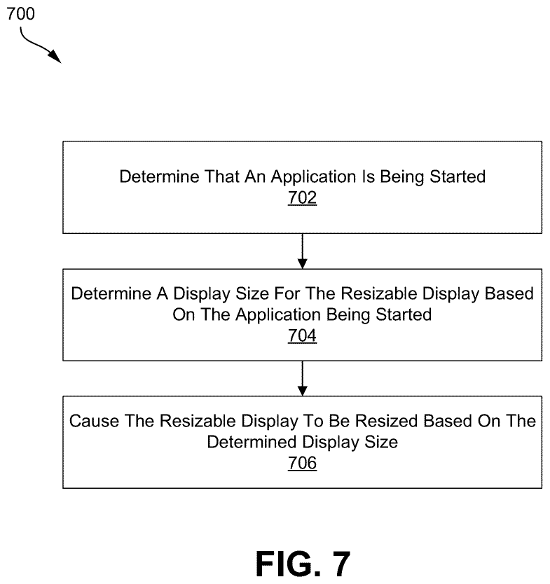

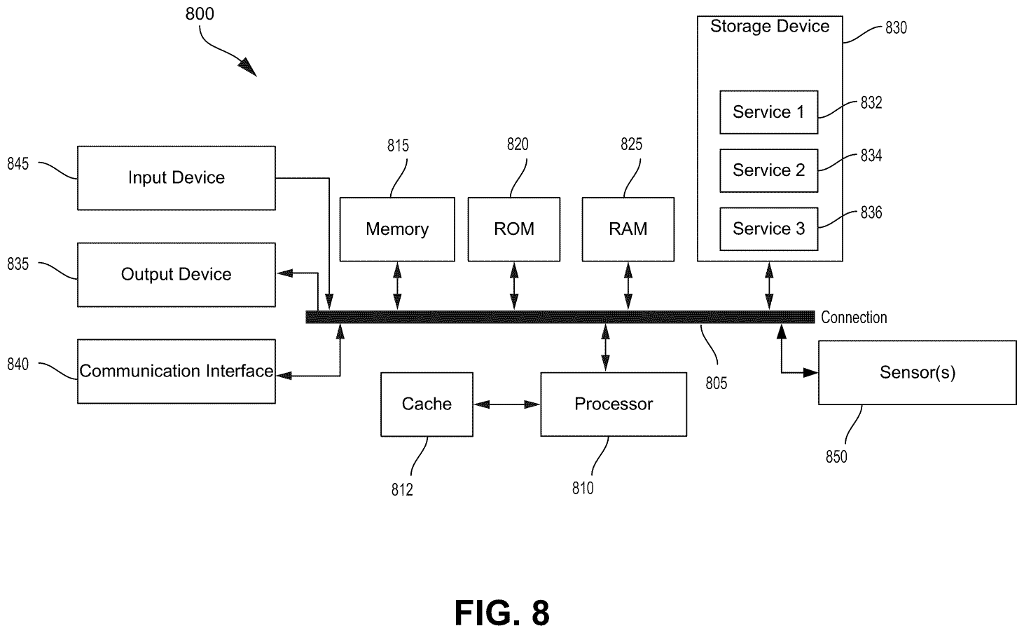

FIG. 7 is a flow diagram for a process 700 for automatically resizing a resizable display, in accordance with aspects of the present disclosure. The process 700 may be performed by a computing device (or apparatus) or a component (e.g., a chipset, codec, etc.) of the computing device, such as a CPU 102 of FIG. 1, display size controller 240 of FIG. 2 and/or processor 810 of FIG. 8. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors (e.g., CPU 102 of FIG. 1, display size controller 240 of FIG. 2 and/or processor 810 of FIG. 8, and/or other processor(s)). In some cases, the operations of the process 700 can be implemented by a system having the computing device architecture 800 of FIG. 8.

At block 702, the computing device (or component thereof) may determine that an application is being started (e.g., similar to that described above with respect to operation 302 of the process 300 of FIG. 3). In some cases, the computing device (or component thereof) may switch among a set of resize modes. In some cases, the set of resize modes comprise at least two of: a first resize mode where automatic resizing is disabled; a second resize mode where automatic resizing is performed absent a prompt to resize; and a third resize mode where a prompt is displayed prior to resizing the resizable display.

At block 704, the computing device (or component thereof) may determine a display size for the resizable display based on the application being started. In some cases, the computing device (or component thereof) may determine the display size based on a previous display size used for the application being started. The computing device (or component thereof) may determine the display size based on a size associated with content of the application and a size of a control interface of the application. In some cases, the determined display size is based on a non-overlapping size of the application and the size of the control interfaces of the application. In some examples, the determined display size is based on a size of the application and a size of the control interfaces of the application such that the control interfaces are non-overlapping with the content of the application. In some examples, the size associated with the content of the application is based on an aspect ratio of a video to be played. In some cases, the control interface comprises an overlay. In some aspects, to determine the display size, the computing device (or component thereof) may display a prompt to resize the resizable display. The computing device (or component thereof) may obtain an input to the prompt. The computing device (or component thereof) can resize the resizable display based on the input to the prompt. In some cases, the prompt includes one or more previously used sizes of the resizable display for the application. In some examples, the display size is determined based on a display orientation associated with the application. In some cases, the computing device (or component thereof) can determine the display size based on a display orientation associated with the application. In some examples, the display size is determined based on information stored in a database, wherein the information stored in the database comprises at least one of a per application display size usage, a count of a size used per application, an orientation of the physically resizable display, or time of day. In some cases, the physically resizable display is an automatic rollable display. In some examples, the resizable display is automatically resized to the determined display size based on contextual information comprising at least one of application display information, display state and device state information, and a resize mode setting.

At block 706, the computing device (or component thereof) may cause the resizable display to be resized based on the determined display size. In some cases, the resizable display is automatically resized to the determined display size based on a resize mode setting.

FIG. 8 illustrates an example computing device architecture 800 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing device architecture 800 may include SOC 100 of FIG. 1. The components of computing device architecture 800 are shown in electrical communication with each other using connection 805, such as a bus. The example computing device architecture 800 includes a processing unit (CPU or processor) 810 and computing device connection 805 that couples various computing device components including computing device memory 815, such as read only memory (ROM) 820 and random access memory (RAM) 825, to processor 810.

Computing device architecture 800 may include one or more sensors 850 coupled to the processor 810 via computing device connection 805. The sensor(s) 850 may include one or more of the sensors in the sensor(s) 850.

Computing device architecture 800 can include a cache of high-speed memory connected directly with, in close proximity to, or integrated as part of processor 810. Computing device architecture 800 can copy data from memory 815 and/or the storage device 830 to cache 812 for quick access by processor 810. In this way, the cache can provide a performance boost that avoids processor 810 delays while waiting for data. These and other modules can control or be configured to control processor 810 to perform various actions. Other computing device memory 815 may be available for use as well. Memory 815 can include multiple different types of memory with different performance characteristics. Processor 810 can include any general purpose processor and a hardware or software service, such as service 1 832, service 2 834, and service 3 836 stored in storage device 830, configured to control processor 810 as well as a special-purpose processor where software instructions are incorporated into the processor design. Processor 810 may be a self-contained system, containing multiple cores or processors, a bus, memory controller, cache, etc. A multi-core processor may be symmetric or asymmetric.

To enable user interaction with the computing device architecture 800, input device 845 can represent any number of input mechanisms, such as a microphone for speech, a touch-sensitive screen for gesture or graphical input, keyboard, mouse, motion input, speech and so forth. Output device 835 can also be one or more of a number of output mechanisms known to those of skill in the art, such as a display, projector, television, speaker device, etc. In some instances, multimodal computing devices can enable a user to provide multiple types of input to communicate with computing device architecture 800. Communication interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. Storage device 830 can include services 832, 834, 836 for controlling processor 810. Other hardware or software modules are contemplated. Storage device 830 can be connected to the computing device connection 805. In one aspect, a hardware module that performs a particular function can include the software component stored in a computer-readable medium in connection with the necessary hardware components, such as processor 810, connection 805, output device 835, and so forth, to carry out the function.

In some cases, the computing device architecture 800 may be a user equipment (UE) that may couple to a wireless communications system.

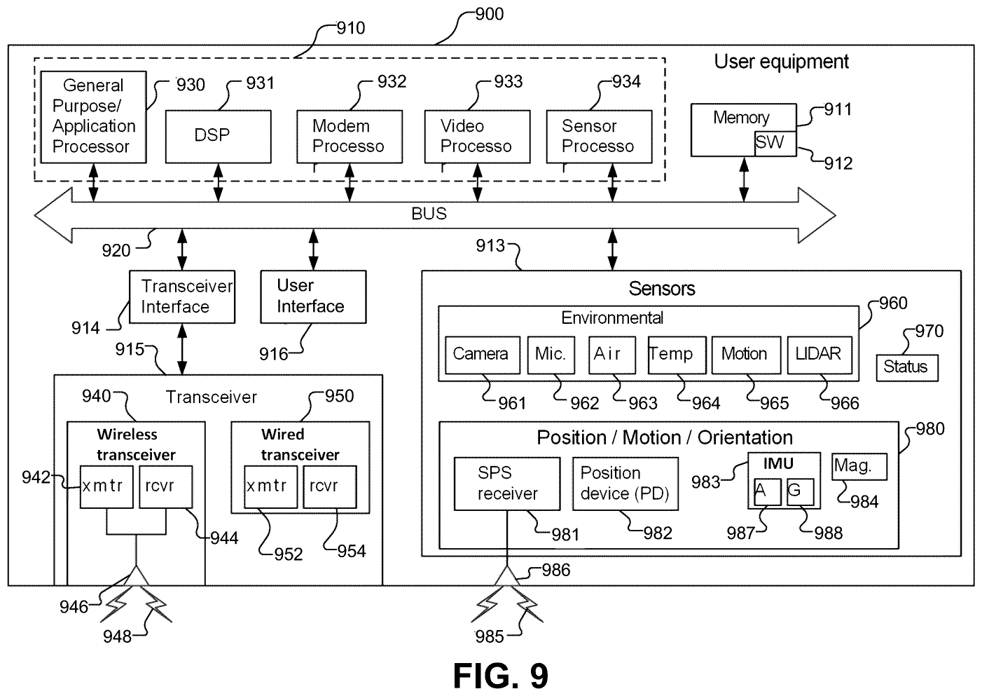

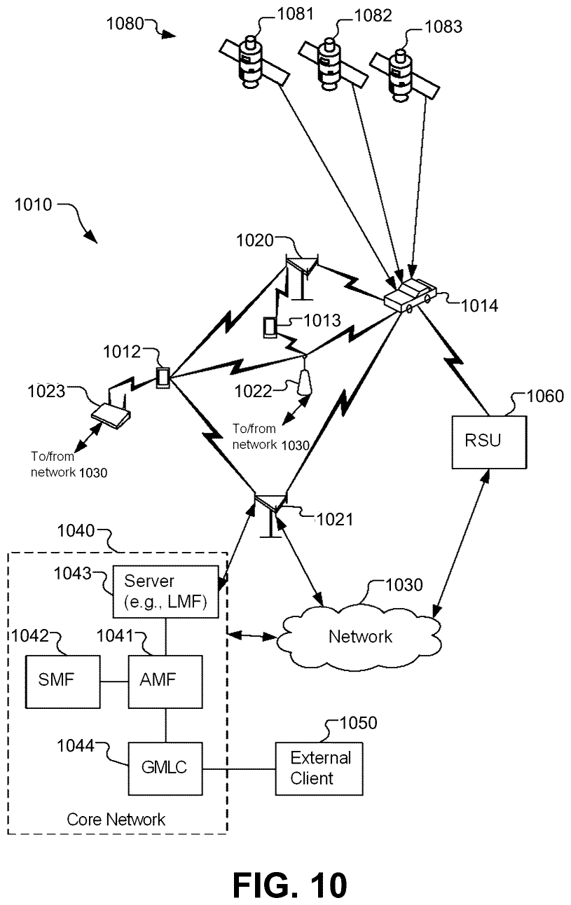

FIG. 9 is a block diagram of a UE 900, in accordance with aspects of the present disclosure. UE 900 may be an example of any of the UEs 1012, 1013, 1014 (as shown below in FIG. 10) and comprises a computing platform including a processor 910, memory 911 including software (SW) 912, one or more sensors 913, a transceiver interface 914 for a transceiver 915 (that includes a wireless transceiver 940 and a wired transceiver 950), and a user interface 916. The processor 910, the memory 911, the sensor(s) 913, the transceiver interface 914, and the user interface 916 may be communicatively coupled to each other by a bus 920 (which may be configured, e.g., for optical and/or electrical communication). One or more of the components shown (e.g., one or more of the sensors 913, etc.) may be omitted from the UE 900.

The processor 910 may include one or more intelligent hardware devices, e.g., a central processing unit (CPU), a microcontroller, an application specific integrated circuit (ASIC), etc. The processor 910 may comprise multiple processors including a general-purpose/application processor 930, a Digital Signal Processor (DSP) 931, a modem processor 932, a video processor 933, and/or a sensor processor 934. One or more of the processors 930-934 may comprise multiple devices (e.g., multiple processors). For example, the sensor processor 934 may comprise, e.g., processors for radar, ultrasound, and/or lidar, etc. The modem processor 932 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 900 for connectivity. The memory 911 is a non-transitory storage medium that may include random access memory (RAM), flash memory, disc memory, and/or read-only memory (ROM), etc. The memory 911 stores the software 912 which may be processor-readable, processor-executable software code containing instructions that are configured to, when executed, cause the processor 910 to perform various functions described herein. Alternatively, the software 912 may not be directly executable by the processor 910 but may be configured to cause the processor 910, e.g., when compiled and executed, to perform the functions. The description may refer only to the processor 910 performing a function, but this includes other implementations such as where the processor 910 executes software and/or firmware. The description may refer to the processor 910 performing a function as shorthand for one or more of the processors 930-934 performing the function. The description may refer to the UE 900 performing a function as shorthand for one or more appropriate components of the UE 900 performing the function. The processor 910 may include a memory with stored instructions in addition to and/or instead of the memory 911. Functionality of the processor 910 is discussed more fully below.

The configuration of the UE 900 shown in FIG. 9 is an example and not limiting of the aspects and features of the disclosure, including the claims, and other configurations may be used. For example, an example configuration of the UE includes one or more of the processors 930-934 of the processor 910, the memory 911, and the wireless transceiver 940. Other example configurations include one or more of the processors 930-934 of the processor 910, the memory 911, the wireless transceiver 940, and one or more of the sensors 913, the user interface 916, and/or the wired transceiver 950.

The UE 900 may comprise the modem processor 932 that may be capable of performing baseband processing of signals received and down-converted by the transceiver 915 and/or the SPS receiver 981 (discussed below). The modem processor 932 may perform baseband processing of signals to be upconverted for transmission by the transceiver 915. Also or alternatively, baseband processing may be performed by the processor 930 and/or the DSP 931. Other configurations, however, may be used to perform baseband processing.

The UE 900 includes the sensors 913 that may include one or more of various types of sensors, for example, an environmental sensor 960, a status sensor 970, and a position/motion/orientation (PMO) sensor 980. The PMO sensor 980 may include one or more sensors from which position and/or motion and/or orientation of the UE 900 may be determined. While each of the sensors 960, 970, 980 may be referred to in the singular, each of the sensors 960, 970, 980 may include more than one sensor, examples of some of which are discussed explicitly herein. The sensors 913 may generate analog and/or digital signals indications of which may be stored in the memory 911 and processed by the processor 910 (e.g., the processor 930, the DSP 931, the video processor 933, and/or the sensor processor 934 as appropriate) in support of one or more applications such as, for example, applications directed to positioning, navigation, and/or resource management. The description herein may refer to the processor 910 generally as performing one or more functions that one or more of the processors 930-934 perform.

The sensor(s) 913 may be used in resource management, relative location measurements, relative location determination, motion determination, etc. Information detected by the sensor(s) 913 may be used to determine how to allocate resources of the UE 900, e.g., transmission power, processing power for transmission and/or reception of communication signals, transmission and/or reception directionality, etc. The plural term “resources” is often used throughout the discussion herein, but this term includes the singular as well, i.e., a single resource, e.g., being allocated. Also or alternatively, information detected by the sensor(s) may be used for motion detection, relative displacement, dead reckoning, sensor-based location determination, and/or sensor-assisted location determination. The sensor(s) 913 may be useful to determine whether the UE 900 is fixed (stationary) or mobile and/or whether to report certain useful information to the server 1043 regarding the mobility of the UE 900. For example, based on the information obtained/measured by the sensor(s) 913, the UE 900 may notify/report to the server 1043 of FIG. 10 that the UE 900 has detected movements or that the UE 900 has moved, and report the relative displacement/distance (e.g., via dead reckoning, or sensor-based location determination, or sensor-assisted location determination enabled by the sensor(s) 913). In another example, for relative positioning information, the sensors/IMU can be used to determine the angle, size (e.g., width and/or height), and/or orientation of another device with respect to the UE 900, etc. The position and/or motion of the UE 900 may be used in determining resource allocation for communication, e.g., between vehicles. The UE 900 may, for example, be disposed in or integrated with a vehicle. For example, the UE 900 may be the UE 1014 of FIG. 10 that is a vehicle, in the example shown in FIG. 10, a car, although other forms of vehicles may be used, e.g., trucks, aerial UEs such as drones, etc. As such, the UE 900 may be configured for various forms of communication, e.g., V2V (vehicle-to-vehicle), V2X (vehicle-to-everything), CV2X (cellular V2X), CV2V (cellular V2V), etc.

The environmental sensor 960 may include one or more sensors for measuring one or more internal and/or external environmental conditions. In this example, the environmental sensor 960 includes a camera 961, a microphone 962, an air-flow sensor 963, a temperature sensor 964, a motion sensor 965, and a LIDAR (Light Detection and Ranging) sensor 966. While each of the sensors 961-966 may be referred to in the singular, each of the sensors 961-966 may include more than one sensor, examples of some of which are discussed explicitly herein. For example, the camera 961 may include at least one camera configured (e.g., designed, made, disposed, and directed) to capture images external to the UE 900 and/or may include one or more cameras configured to capture images internal to the UE 900 (e.g., in a passenger compartment of a vehicle). As other examples, the microphone 962, the temperature sensor 964, and/or the motion sensor 965 may include multiple microphones, multiple thermometers, and/or multiple motion detectors configured to detect sound, temperature, and/or motion (respectively) outside and/or inside of the UE 900, e.g., a vehicle. Indeed, any of the sensors 961-965 may include multiple respective sensors outside the vehicle and/or multiple respective sensors inside the vehicle for making respective measurements at multiple locations about the vehicle and/or in different directions relative to the vehicle. While this discussion assumes the UE 900 is a vehicle, the UE 900 may be a different device (i.e., other than a vehicle). The sensors 961-965 are examples and one or more of the sensors 961-965 may be omitted from the UE 900 and/or one or more other sensors may be included in the UE 900. For example, the environmental sensor 960 may include one or more barometric pressure sensors and/or one or more ambient light sensors and/or one or more other sensors.

The camera 961 may be configured for capturing still and/or moving imagery. For example, each camera of the camera 961 may comprise, for example, one or more imaging sensors (e.g., a charge coupled device (CCD) or a CMOS imager), one or more lenses, analog-to-digital circuitry, frame buffers, etc. Additional processing, conditioning, encoding, and/or compression of signals representing captured images may be performed by the general-purpose processor 930 and/or the DSP 931. Also or alternatively, the video processor 933 may perform conditioning, encoding, compression, and/or manipulation of signals representing captured images. The video processor 933 may decode/decompress stored image data for presentation on a display device (not shown), e.g., of the user interface 916.

The motion sensor 965 is configured to detect motion. For example, the motion sensor 965 may send and receive sound waves (e.g., ultrasound signals) and analyze the received signals for Doppler effects indicative of motion. Use of multiple motion detectors may help identify the relative location (e.g., direction relative to the UE 900) of an object.

The LIDAR sensor 966 is configured to determine range to an object, which may be used by the processor 910 to detect the presence of an object. Use of multiple LIDAR sensors may help identify the relative location (e.g., direction relative to the UE 900) of an object. The LIDAR sensor 966 may be called a LADAR (laser radar) sensor, as is common when using a LIDAR sensor for detecting relatively small objects such as vehicles or other artificial (human-made) objects.

The status sensor 970 is configured to provide one or more indications of one or more UE conditions of the UE 900 indicative of UE status. For example, UE conditions where the UE 900 is a vehicle (with UE conditions thus being vehicle conditions) may include a gear status of the vehicle (e.g., whether the vehicle is in park, drive, or neutral, or in which gear the vehicle is presently (e.g., reverse, first, second, third, fourth, etc.)). Another vehicle condition may be whether an emergency brake is engaged. Another vehicle condition may be whether a main brake is presently engaged and possibly engaged to what degree. Another vehicle condition may be whether an accelerator is presently engaged and possibly to what degree. Another vehicle condition may be the status of the steering wheel (e.g., turned which way and how much) and/or wheel(s) directing the vehicle (e.g., direction of front wheels). Other example vehicle conditions may include whether a right-turn indicator is actuated, whether a left-turn indicator is actuated, and/or whether hazard lights (also called “four ways” or emergency flashers, etc.) are actuated. Another example vehicle condition may include tire status (e.g., tire pressure, rate of tire pressure change (e.g., to indicate a flat or blowout)). Another example vehicle condition is speed, e.g., as registered by a speedometer of the vehicle and/or determined by other means (e.g., using the PMO sensor 980). These vehicle conditions are examples, and one or more other sensors may be provided to sense one or more other vehicle conditions. Further, numerous other UE conditions may be sensed and indicated where the UE 900 is not a vehicle or is not associated with a vehicle.

The PMO sensor 980 may include one or more sensors for providing one or more UE conditions such as, for example, vehicle conditions. For example, the PMO sensor 980 may include one or more sensors for measuring information from which position and/or motion and/or orientation of the UE 900 may be determined and possibly determining position and/or motion (e.g., speed and/or direction of motion) and/or orientation of the UE 900. In this example, the PMO sensor 980 includes a Satellite Positioning System (SPS) receiver 981, a position device (PD) 982, an Inertial Measurement Unit (IMU) 983, and a magnetometer 984. The components of the PMO sensor 980 shown are examples, and one or more of these components may be omitted and/or one or more other components included in the PMO sensor 980. Also, while each of the components 981-984 of the PMO sensor 980 may be referred to in the singular, each of the components 981-984 may include more than one such component, examples of some of which are discussed explicitly herein. Also, the PD 982 may be part of the SPS receiver 981 and/or the IMU 983 and/or part of the processor 910, and may not be a sensor itself (e.g., may not take measurements), but may process information from one or more of the components 981-984 and/or one or more other sensors. The PMO sensor 980 may be used to determine UE speed and/or direction of motion, e.g., by determining UE location over time (e.g., determined using SPS, one or more ranging sensors, etc.).

The IMU 983 may comprise one or more inertial sensors, for example, an accelerometer 987 (e.g., responding to acceleration of the UE 900 in three dimensions) and/or a gyroscope 988. While each of the sensors 987, 988 may be referred to in the singular, each of the sensors 987, 988 may include more than one sensor. The accelerometer may include one or more three-dimensional accelerometers and the gyroscope may include one or more three-dimensional gyroscopes. The IMU 983 may be configured to provide measurements about a direction of motion and/or a speed of motion of the UE 900, which may be used, for example, in relative location determination. For example, the accelerometer 987 and/or the gyroscope 988 of the IMU 983 may detect, respectively, a linear acceleration and a speed of rotation of the UE 900. The linear acceleration and speed of rotation measurements of the UE 900 may be integrated over time (e.g., by the IMU 983 and/or the PD 982) to determine an instantaneous direction of motion as well as a displacement of the UE 900. The instantaneous direction of motion and the displacement may be integrated to track a location of the UE 900. For example, a reference location of the UE 900 may be determined, e.g., using the SPS receiver 981 (and/or by some other means) for a moment in time and measurements from the accelerometer 987 and the gyroscope 988 taken after this moment in time may be used in dead reckoning to determine a present location of the UE 900 based on movement (direction and distance) of the UE 900 relative to the reference location.

The magnetometer 984 may determine magnetic field strengths in different directions which may be used to determine orientation of the UE 900, which may be used, for example, to provide a digital compass for the UE 900. The magnetometer 984 may include a two-dimensional magnetometer configured to detect and provide indications of magnetic field strength in two orthogonal dimensions. Also or alternatively, the magnetometer 984 may include a three-dimensional magnetometer configured to detect and provide indications of magnetic field strength in three orthogonal dimensions. The magnetometer 984 may provide means for sensing a magnetic field and providing indications of the magnetic field, e.g., to the processor 910. The magnetometer 984 may provide measurements to determine orientation (e.g., relative to magnetic north and/or true north) that may be used for any of a variety of purposes, e.g., to support one or more compass applications. While referred to in the singular, the magnetometer 984 may include multiple magnetometers.

The SPS receiver 981 (e.g., a Global Positioning System (GPS) receiver or other Global Navigation Satellite System (GNSS) receiver) may be capable of receiving and acquiring SPS signals 985 via an SPS antenna 986. The antenna 986 is configured to transduce the wireless SPS signals 985 to wired signals, e.g., electrical or optical signals, and may be integrated with the antenna 946. The SPS receiver 981 may be configured to process, in whole or in part, the acquired SPS signals 985 for estimating a location of the UE 900. For example, the SPS receiver 981 may be configured to determine location of the UE 900 by trilateration using the SPS signals 985. The general-purpose processor 930, the memory 911, the DSP 931 and/or one or more specialized processors (not shown) may be utilized to process acquired SPS signals, in whole or in part, and/or to calculate an estimated location of the UE 900, in conjunction with the SPS receiver 981. The memory 911 may store indications (e.g., measurements) of the SPS signals 985 and/or other signals (e.g., signals acquired from the wireless transceiver 940) for use in performing positioning operations. The general-purpose processor 930, the DSP 931, and/or one or more specialized processors, and/or the memory 911 may provide or support a location engine for use in processing measurements to estimate a location of the UE 900. Also or alternatively, some or all of the position determination signal processing may be performed by the PD 982.

The position device (PD) 982 may be configured to determine a position of the UE 900 (including absolute and/or relative position of the UE 900), motion of the UE 900, and/or time. For example, the PD 982 may communicate with, and/or include some or all of, the SPS receiver 981. The PD 982 may use measurements from the SPS receiver 981 and/or the IMU 983 and/or the magnetometer 984 to determine position and/or motion of the UE 900, e.g., using trilateration and/or dead reckoning. The PD 982 may work in conjunction with the processor 910 and the memory 911 as appropriate to perform at least a portion of one or more positioning methods (to determine location of the UE 900), although the description herein may refer only to the PD 982 being configured to perform, or performing, one or more operations in accordance with the positioning method(s). The PD 982 may also or alternatively be configured to determine location of the UE 900 using terrestrial-based signals (e.g., at least some of signals 948 discussed below) for trilateration, for assistance with obtaining and using the SPS signals 985, or both. The PD 982 may be configured to use one or more other techniques (e.g., relying on the UE's self-reported location (e.g., part of the UE's position beacon)) for determining the location of the UE 900, and may use a combination of techniques (e.g., SPS and terrestrial positioning signals) to determine the location of the UE 900. The PD 982 may be configured to provide indications of uncertainty and/or error in the determined position and/or motion. Functionality of the PD 982 may be provided in a variety of manners and/or configurations, e.g., by the general purpose/application processor 930, the transceiver 915, the SPS receiver 981, and/or another component of the UE 900, and may be provided by hardware, software, firmware, or various combinations thereof.

The transceiver 915 may include a wireless transceiver 940 and/or a wired transceiver 950 configured to communicate with other devices through wireless connections and wired connections, respectively. For example, the wireless transceiver 940 may include a wireless transmitter 942 and a wireless receiver 944 coupled to one or more antennas 946 for transmitting (e.g., on one or more uplink channels and/or one or more sidelink channels) and/or receiving (e.g., on one or more downlink channels and/or one or more sidelink channels) wireless signals 948 and transducing signals from the wireless signals 948 to wired (e.g., electrical and/or optical) signals and from wired signals to the wireless signals 948. The wireless transceiver 940 may be configured for wireless communication to send communications to, and receive communications from, a variety of entities such as other UEs, base stations, etc. Thus, the wireless transmitter 942 may include multiple transmitters that may be discrete components or combined/integrated components, and/or the wireless receiver 944 may include multiple receivers that may be discrete components or combined/integrated components. The wireless transceiver 940 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHZ frequencies. The wired transceiver 950 may include a wired transmitter 952 and a wired receiver 954 configured for wired communication, e.g., a network interface that may communicate with the network 1030 of FIG. 10, e.g., to send communications to, and receive communications from, a gNB, for example. The wired transmitter 952 may include multiple transmitters that may be discrete components or combined/integrated components, and/or the wired receiver 954 may include multiple receivers that may be discrete components or combined/integrated components. The wired transceiver 950 may be configured, e.g., for optical communication and/or electrical communication. The transceiver 915 may be communicatively coupled to the transceiver interface 914, e.g., by optical and/or electrical connection. The transceiver interface 914 may be at least partially integrated with the transceiver 915.

The wireless transceiver 940 may be configured for beam management to affect directionality of the wireless transceiver 940, e.g., of the antenna 946. For example, the wireless transceiver 940 may be configured to implement beam forming for transmission and/or reception of the signals 948. The antenna 946 may include multiple antennas that are configured, e.g., designed, made, disposed, and directed to point in different directions relative to a body of the UE 900. One or more of such antennas may be capable of electronic beam steering (e.g., using appropriate phase shifts of elements of the antenna) and/or mechanical beam steering. Also or alternatively, the transceiver 940 may be configured to selectively (e.g., under direction/control of the processor 910) transmit from one or more antennas and/or to selectively process signals (e.g., to pass from the transceiver 915 to the processor 910 or to process by the processor 910) received from one or more antennas.

The user interface 916 may comprise one or more of several devices such as, for example, a speaker, microphone, display device, vibration device, keyboard, touch screen, etc. The user interface 916 may include more than one of any of these devices. The user interface 916 may be configured to enable a user to interact with one or more applications hosted by the UE 900. For example, the user interface 916 may store indications of analog and/or digital signals in the memory 911 to be processed by DSP 931 and/or the general-purpose processor 930 in response to action from a user. Similarly, applications hosted on the UE 900 may store indications of analog and/or digital signals in the memory 911 to present an output signal to a user. The user interface 916 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 916 may comprise one or more touch sensors responsive to touching and/or pressure, e.g., on a keyboard and/or touch screen of the user interface 916.

FIG. 10 illustrates an example wireless communications system 1010, in accordance with aspects of the present disclosure. Wireless communications system 1010 includes a user equipment (UE) 1012, a UE 1013, a UE 1014, base transceiver stations (BTSs) 1020, 1021, 1022, 1023, a network 1030, a core network 1040, an external client 1050, and a roadside unit (RSU) 1060. The core network 1040 (e.g., a 5G core network (5GC)) may include back-end devices including, among other things, an Access and Mobility Management Function (AMF) 1041, a Session Management Function (SMF) 1042, a server 1043, and a Gateway Mobile Location Center (GMLC) 1044. The AMF 1041, the SMF 1042, the server 1043, and the GMLC 1044 are communicatively coupled to each other. The server 1043 may be, for example, a Location Management Function (LMF) that supports positioning of the UEs 1012-1014 (e.g., using techniques such as Assisted Global Navigation Satellite System (A-GNSS), OTDOA (Observed Time Difference of Arrival, e.g., Downlink (DL) OTDOA and/or Uplink (UL) OTDOA), Round Trip Time (RTT), Multi-Cell RTT, RTK (Real Time Kinematic), PPP (Precise Point Positioning), DGNSS (Differential GNSS), E-CID (Enhanced Cell ID), AoA (Angle of Arrival), AoD (Angle of Departure), etc.). The RSU 1060 may be configured for communication (e.g., bi-directional or uni-directional communication) with the UEs 1012-1014). For example, the RSU 1060 may be configured with similar communication capabilities to any of the BTSs 1020-1023, but perhaps with different functionality(ies) (e.g., different programming). Also, while one RSU 1060 is shown in FIG. 10, the system 1010 may include more than one RSU, or may not include any RSUs. The communication system 1010 may include additional or alternative components.

The communication system 1010 may utilize information from a constellation 1080 of satellite vehicles (SVs) 1081, 1082, 1083. The constellation 1080 may correspond to a respective Global Navigation Satellite System (GNSS) (i.e., Satellite Positioning System (SPS)) such as the Global Positioning System (GPS), the GLObal NAvigation Satellite System (GLONASS), Galileo, Beidou, or some other local or regional SPS such as the Indian Regional Navigational Satellite System (IRNSS), the European Geostationary Navigation Overlay Service (EGNOS), or the Wide Area Augmentation System (WAAS). Only three SVs are shown for the constellation 1080, but constellations of GNSS SVs will include more than three SVs.

An LMF may also be referred to as a Location Manager (LM), a Location Function (LF), a commercial LMF (CLMF), or a value-added LMF (VLMF). The server 1043 (e.g., an LMF) and/or one or more other devices of the system 1010 (e.g., one or more of the UEs 1012-1014) may be configured to determine locations of the UEs 1012-1014. The server 1043 may communicate directly with the BTS 1021 (e.g., a gNB) and/or one or more other BTSs, and may be integrated with the BTS 1021 and/or one or more other BTSs. The SMF 1042 may serve as an initial contact point of a Service Control Function (SCF) (not shown) to create, control, and delete media sessions. The server 1043 (e.g., an LMF) may be co-located or integrated with a gNB or a TRP (Transmission/Reception Point), or may be disposed remote from the gNB and/or TRP and configured to communicate directly or indirectly with the gNB and/or the TRP.

The AMF 1041 may serve as a control node that processes signaling between the UEs 1012-1014 and the core network 1040, and provides QoS (Quality of Service) flow and session management. The AMF 1041 may support mobility of the UEs 1012-1014 including cell change and handover and may participate in supporting signaling connection to the UEs 1012-1014.

The system 1010 is capable of wireless communication in that components of the system 1010 can communicate with one another (at least some times using wireless connections) directly or indirectly, e.g., via the BTSs 1020-1023 and/or the network 1030 (and/or one or more other devices not shown, such as one or more other base transceiver stations). While the BTSs 1020-1023 are shown separately from the network 1030, the network 1030 may include one or more of the BTSs 1020-1023 and may constitute a Radio Access Network (RAN), e.g., a New Radio (NR) RAN which may also be called a Fifth Generation (5G) Next Generation (NG) RAN (NG-RAN). For indirect communications, the communications may be altered during transmission from one entity to another, e.g., to alter header information of data packets, to change format, etc. The UEs 1012-1014 may communicate with the BTSs 1020-1023 via Uu interfaces, e.g., in RRC-encapsulated LPP messages (Radio Resource Control encapsulated LTE Positioning Protocol messages) over Uu interfaces. The UEs 1012-1014 shown are a smartphone, a tablet computer, and a vehicle-based device, but these are examples only as the UEs 1012-1014 are not required to be any of these configurations, and other configurations of UEs may be used. The UEs 1012-1014, the BTSs 1020-1023, the network 1030, the core network 1040, and/or the external client 1050. For example, such other devices may include internet of thing (IoT) devices, medical devices, home entertainment and/or automation devices, etc. The core network 1040 may communicate with the external client 1050 (e.g., a computer system), e.g., to allow the external client 1050 to request and/or receive location information regarding the UEs 1012-1014 (e.g., via the GMLC 1044).

The UEs 1012-1014 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (e.g., V2P (Vehicle-to-Pedestrian), V2I (Vehicle-to-Infrastructure), V2V (Vehicle-to-Vehicle), etc.), IEEE 802.81p, etc.). V2X communications may be cellular (Cellular-V2X (C-V2X)) and/or WiFi (e.g., DSRC (Dedicated Short-Range Connection)). The system 1010 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc.

The BTSs 1020-1023 may wirelessly communicate with the UEs 1012-1014 in the system 1010 via one or more antennas. A BTS may also be referred to as a base station, an access point, a gNode B (gNB), an access node (AN), a Node B, an evolved Node B (eNB), etc. For example, each of the BTSs 1020, 1021 may be a gNB or a transmission point gNB, the BTS 1022 may be a macro cell (e.g., a high-power cellular base station) and/or a small cell (e.g., a low-power cellular base station), and the BTS 1023 may be an access point (e.g., a short-range base station configured to communicate with short-range technology such as WiFi, WiFi-Direct (WiFi-D), Bluetooth®, Bluetooth®-low energy (BLE), Zigbee, etc. One or more of the BTSs 1020-1023 may be configured to communicate with the UEs 1012-1014 via multiple carriers. Each of the BTSs 1020, 1021 may provide communication coverage for a respective geographic region, e.g. a cell. Each cell may be partitioned into multiple sectors as a function of the base station antennas.

The BTSs 1020-1023 each comprise one or more Transmission/Reception Points (TRPs). For example, each sector within a cell of a BTS may comprise a TRP, although multiple TRPs may share one or more components (e.g., share a processor but have separate antennas). The system 1010 may include only macro TRPs or the system 1010 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

The UEs 1012-1014 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, Ultrawideband (UWB), and so on. One or more of a group of the UEs 1012-1014 utilizing D2D communications may be within a geographic coverage area of a TRP such as one or more of the BTSs 1020-1023. Other UEs in such a group may be outside such geographic coverage areas, or be otherwise unable to receive transmissions from a base station. Groups of the UEs 1012-1014 communicating via D2D communications may utilize a one-to-many (8:M) system in which each UE may transmit to other UEs in the group. A TRP of the BTSs 1020-1023 may facilitate scheduling of resources for D2D communications. In other cases, D2D communications may be carried out between UEs without the involvement of a TRP.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus, comprising: a memory; a resizable display; and a processor coupled to the memory, wherein the processor is configured to: determine an application is being started; determine a display size for the resizable display based on the application being started; and resize the resizable display based on the determined display size.

Aspect 2. The apparatus of Aspect 1, wherein the processor is configured to determine the display size based on a previous display size used for the application being started.

Aspect 3. The apparatus of any of Aspects 1-2, wherein the processor is configured to determine the display size based on a size associated with content of the application and a size of a control interface of the application.

Aspect 4. The apparatus of Aspect 3, wherein the determined display size is based on a non-overlapping size of the application and the size of the control interfaces of the application.

Aspect 5. The apparatus of any of Aspect 3-4, wherein the size associated with the content of the application is based on an aspect ratio of a video to be played.

Aspect 6. The apparatus of any of Aspect 3-5, wherein the control interface comprises an overlay.

Aspect 7. The apparatus of any of Aspects 1-6, wherein, to determine the display size, the processor is configured to: display a prompt to resize the resizable display; obtain an input to the prompt; and resize the resizable display based on the input to the prompt.

Aspect 8. The apparatus of Aspect 7, wherein the prompt includes one or more previously used sizes of the resizable display for the application.

Aspect 9. The apparatus of any of Aspects 1-8, wherein the display size is determined based on a display orientation associated with the application.

Aspect 10. The apparatus of any of Aspects 1-9, wherein the resizable display is automatically resized to the determined display size based on a resize mode setting.

Aspect 11. A method for resizing a display, comprising: determining an application is being started; determining a display size for a resizable display based on the application being started; and resizing the resizable display based on the determined display size.

Aspect 12. The method of Aspect 11, further comprising determining the display size based on a previous display size used for the application being started.

Aspect 13. The method of any of Aspects 11-12, further comprising determining the display size based on a size associated with content of the application and a size of a control interface of the application.

Aspect 14. The method of Aspect 13, wherein the determined display size is based on a non-overlapping size of the application and the size of the control interfaces of the application.

Aspect 15. The method of any of Aspects 13-14, wherein the size associated with the content of the application is based on an aspect ratio of a video to be played.

Aspect 16. The method of any of Aspects 13-15, wherein the control interface comprises an overlay.

Aspect 17. The method of any of Aspects 11-16, wherein determining the display size comprises: displaying a prompt to resize the resizable display; obtaining an input to the prompt; and resizing the resizable display based on the input to the prompt.

Aspect 18. The method of Aspect 17, wherein the prompt includes one or more previously used sizes of the resizable display for the application.

Aspect 19. The method of any of Aspects 11-18, wherein the display size is determined based on a display orientation associated with the application.

Aspect 20. The method of any of Aspects 11-19, wherein the resizable display is automatically resized to the determined display size based on a resize mode setting.

Aspect 21. A non-transitory computer-readable medium having stored thereon instructions that, when executed by at least one processor, cause the at least one processor to: determine an application is being started; determine a display size for a resizable display based on the application being started; and resize the resizable display based on the determined display size.

Aspect 22. The non-transitory computer-readable medium of Aspect 21, wherein the instructions cause the at least one processor to determine the display size based on a previous display size used for the application being started.

Aspect 23. The non-transitory computer-readable medium of any of Aspects 21-22, wherein the instructions cause the at least one processor to determine the display size based on a size associated with content of the application and a size of a control interface of the application.

Aspect 24. The non-transitory computer-readable medium of Aspect 23, wherein the determined display size is based on a non-overlapping size of the application and the size of the control interfaces of the application.

Aspect 25. The non-transitory computer-readable medium of any of Aspects 23-24, wherein the size associated with the content of the application is based on an aspect ratio of a video to be played.

Aspect 26. The non-transitory computer-readable medium of any of Aspects 23-25, wherein the control interface comprises an overlay.

Aspect 27. The non-transitory computer-readable medium of any of Aspects 21-26, wherein, to determine the display size, the instructions cause the at least one processor to: display a prompt to resize the resizable display; obtain an input to the prompt; and resize the resizable display based on the input to the prompt.

Aspect 28. The non-transitory computer-readable medium of Aspect 27, wherein the prompt includes one or more previously used sizes of the resizable display for the application.

Aspect 29. The non-transitory computer-readable medium of any of Aspects 21-28, wherein the display size is determined based on a display orientation associated with the application.

Aspect 30. The non-transitory computer-readable medium of any of Aspects 21-29, wherein the resizable display is automatically resized to the determined display size based on a resize mode setting.

Aspect 31. An apparatus comprising one or more means for performing operations according to any of Aspects 11 to 20.

Aspect 32. An apparatus, comprising: a memory; a physically resizable display; and at least one processor coupled to the memory, wherein the at least one processor is configured to: determine that an application is being started; determine a display size for the resizable display based on the application being started; and cause the resizable display to be resized based on the determined display size.

Aspect 33. The apparatus of Aspect 32, wherein the at least one processor is configured to determine the display size based on a previous display size used for the application being started.

Aspect 34. The apparatus of any of Aspects 32-34, wherein the at least one processor is configured to determine the display size based on a size associated with content of the application and a size of a control interface of the application.

Aspect 35. The apparatus of Aspect 34, wherein the determined display size is based on a size of the application and a size of the control interfaces of the application such that the control interfaces are non-overlapping with the content of the application.

Aspect 36. The apparatus of Aspect 34, wherein the size associated with the content of the application is based on an aspect ratio of a video to be played.

Aspect 37. The apparatus of any of Aspects 32-36, wherein the display size is determined based on information stored in a database, wherein the information stored in the database comprises at least one of a per application display size usage, a count of a size used per application, an orientation of the physically resizable display, or time of day.

Aspect 38. The apparatus of any of Aspects 32-37, wherein, to determine the display size, the at least one processor is configured to: display a prompt to resize the resizable display; obtain an input to the prompt; and resize the resizable display based on the input to the prompt.

Aspect 39. The apparatus of Aspect 38, wherein the prompt includes one or more previously used sizes of the resizable display for the application.

Aspect 40. The apparatus of any of Aspects 32-39, wherein, to determine the display size, the at least one processor is configured to determine the display size based on a display orientation associated with the application.

Aspect 41. The apparatus of any of Aspects 32-40, wherein the resizable display is automatically resized to the determined display size based on a resize mode setting.

Aspect 42. The apparatus of any of Aspects 32-41, wherein the physically resizable display is an automatic rollable display.

Aspect 43. The apparatus of any of Aspects 32-42, wherein the at least one processor is further configured to switch among a set of resize modes, wherein resize modes, of the set of resize modes comprise at least two of: a first resize mode where automatic resizing is disabled; a second resize mode where automatic resizing is performed absent a prompt to resize; and a third resize mode where a prompt is displayed prior to resizing the resizable display.

Aspect 44. The apparatus of any of Aspects 32-43, wherein the resizable display is automatically resized to the determined display size based on contextual information comprising at least one of application display information, display state and device state information, and a resize mode setting.

Aspect 45. A method for operating a physically resizable display, comprising: determining that an application is being started; determining a display size for a resizable display based on the application being started; and cause the resizable display to be resized based on the determined display size.

Aspect 46. The method of Aspect 45, further comprising determining the display size based on a previous display size used for the application being started.

Aspect 47. The method of any of Aspects 45-46, further comprising determining the display size based on a size associated with content of the application and a size of a control interface of the application.

Aspect 48. The method of Aspect 47, wherein the determined display size is based on a size of the application and the size of the control interfaces of the application such that the control interfaces are non-overlapping with the content of the application.

Aspect 49. The method of Aspect 47, wherein the size associated with the content of the application is based on an aspect ratio of a video to be played.

Aspect 50. The method of any of Aspects 45-49, wherein the display size is determined based on information stored in a database, wherein the information stored in the database comprises at least one of a per application display size usage, a count of a size used per application, an orientation of the physically resizable display, or time of day.

Aspect 51. The method of any of Aspects 45-50, wherein determining the display size comprises: displaying a prompt to resize the resizable display; obtaining an input to the prompt; and resizing the resizable display based on the input to the prompt.

Aspect 52. The method of Aspect 51, wherein the prompt includes one or more previously used sizes of the resizable display for the application.

Aspect 53. The method of any of Aspects 45-52, wherein determining the display size comprises determining the display size based on a display orientation associated with the application.

Aspect 54. The method of any of Aspects 45-53, wherein the resizable display is automatically resized to the determined display size based on a resize mode setting.

Aspect 55. The method of any of Aspects 45-54, wherein the physically resizable display is an automatic rollable display.

Aspect 56. The method of any of Aspects 45-55, further comprising switching among a set of resize modes, wherein resize modes, of the set of resize modes comprise at least two of: a first resize mode where automatic resizing is disabled; a second resize mode where automatic resizing is performed absent a prompt to resize; and a third resize mode where a prompt is displayed prior to resizing the resizable display.

Aspect 57. The method of any of Aspects 45-56, wherein the resizable display is automatically resized to the determined display size based on contextual information comprising at least one of application display information, display state and device state information, and a resize mode setting.

Aspect 58. A non-transitory computer-readable medium having stored thereon instructions that, when executed by at least one processor, cause the at least one processor to: determine that an application is being started; determine a display size for a physically resizable display based on the application being started; and cause the resizable display to be resized based on the determined display size.

Aspect 59. The non-transitory computer-readable medium of Aspect 58, wherein the instructions cause the at least one processor to determine the display size based on a previous display size used for the application being started.

Aspect 60. The non-transitory computer-readable medium of any of Aspects 58-59, wherein the instructions cause the at least one processor to determine the display size based on a size associated with content of the application and a size of a control interface of the application.

Aspect 61. The non-transitory computer-readable medium of Aspect 60, wherein the determined display size is based on a size of the application and the size of the control interfaces of the application such that the control interfaces are non-overlapping with the content of the application.

Aspect 62. A non-transitory computer-readable medium having stored thereon instructions that, when executed by at least one processor, cause the at least one processor to perform operations according to any of Aspects 45-57.

Aspect 31. An apparatus comprising one or more means for performing operations according to any of Aspects 45 to 57.

What is claimed is:

1. An apparatus, comprising:
a memory;
a physically resizable display; and
at least one processor coupled to the memory, wherein the at least one processor is configured to:
determine that an application is being started;
determine a display size for the resizable display based on the application being started; and
cause the resizable display to be resized based on the determined display size.

2. The apparatus of claim 1, wherein the at least one processor is configured to determine the display size based on a previous display size used for the application being started.

3. The apparatus of claim 1, wherein the at least one processor is configured to determine the display size based on a size associated with content of the application and a size of a control interface of the application.

4. The apparatus of claim 3, wherein the determined display size is based on a size of the application and a size of the control interfaces of the application such that the control interfaces are non-overlapping with the content of the application.

5. The apparatus of claim 3, wherein the size associated with the content of the application is based on an aspect ratio of a video to be played.

6. The apparatus of claim 1, wherein the display size is determined based on information stored in a database, wherein the information stored in the database comprises at least one of a per application display size usage, a count of a size used per application, an orientation of the physically resizable display, or time of day.

7. The apparatus of claim 1, wherein, to determine the display size, the at least one processor is configured to:
display a prompt to resize the resizable display;
obtain an input to the prompt; and
resize the resizable display based on the input to the prompt.

8. The apparatus of claim 7, wherein the prompt includes one or more previously used sizes of the resizable display for the application.

9. The apparatus of claim 1, wherein, to determine the display size, the at least one processor is configured to determine the display size based on a display orientation associated with the application.

10. The apparatus of claim 1, wherein the resizable display is automatically resized to the determined display size based on a resize mode setting.

11. The apparatus of claim 1, wherein the physically resizable display is an automatic rollable display.

12. The apparatus of claim 1, wherein the at least one processor is further configured to switch among a set of resize modes, wherein resize modes, of the set of resize modes comprise at least two of:
a first resize mode where automatic resizing is disabled;
a second resize mode where automatic resizing is performed absent a prompt to resize; and
a third resize mode where a prompt is displayed prior to resizing the resizable display.

13. The apparatus of claim 1, wherein the resizable display is automatically resized to the determined display size based on contextual information comprising at least one of application display information, display state and device state information, and a resize mode setting.

14. A method for operating a physically resizable display, comprising:
determining that an application is being started;
determining a display size for a resizable display based on the application being started; and
cause the resizable display to be resized based on the determined display size.

15. The method of claim 14, further comprising determining the display size based on a previous display size used for the application being started.

16. The method of claim 14, further comprising determining the display size based on a size associated with content of the application and a size of a control interface of the application.

17. The method of claim 16, wherein the determined display size is based on a size of the application and the size of the control interfaces of the application such that the control interfaces are non-overlapping with the content of the application.

18. The method of claim 16, wherein the size associated with the content of the application is based on an aspect ratio of a video to be played.

19. The method of claim 14, wherein the display size is determined based on information stored in a database, wherein the information stored in the database comprises at least one of a per application display size usage, a count of a size used per application, an orientation of the physically resizable display, or time of day.

20. The method of claim 14, wherein determining the display size comprises:
displaying a prompt to resize the resizable display;
obtaining an input to the prompt; and
resizing the resizable display based on the input to the prompt.

21. The method of claim 20, wherein the prompt includes one or more previously used sizes of the resizable display for the application.

22. The method of claim 14, wherein determining the display size comprises determining the display size based on a display orientation associated with the application.

23. The method of claim 14, wherein the resizable display is automatically resized to the determined display size based on a resize mode setting.

24. The method of claim 14, wherein the physically resizable display is an automatic rollable display.

25. The method of claim 14, further comprising switching among a set of resize modes, wherein resize modes, of the set of resize modes comprise at least two of:
a first resize mode where automatic resizing is disabled;
a second resize mode where automatic resizing is performed absent a prompt to resize; and
a third resize mode where a prompt is displayed prior to resizing the resizable display.

26. The method of claim 14, wherein the resizable display is automatically resized to the determined display size based on contextual information comprising at least one of application display information, display state and device state information, and a resize mode setting.

27. A non-transitory computer-readable medium having stored thereon instructions that, when executed by at least one processor, cause the at least one processor to:
determine that an application is being started;
determine a display size for a physically resizable display based on the application being started; and
cause the resizable display to be resized based on the determined display size.

28. The non-transitory computer-readable medium of claim 27, wherein the instructions cause the at least one processor to determine the display size based on a previous display size used for the application being started.

29. The non-transitory computer-readable medium of claim 27, wherein the instructions cause the at least one processor to determine the display size based on a size associated with content of the application and a size of a control interface of the application.

30. The non-transitory computer-readable medium of claim 29, wherein the determined display size is based on a size of the application and the size of the control interfaces of the application such that the control interfaces are non-overlapping with the content of the application.
